(19) United States
(12) Patent Application Publication
(10) Pub. No.: US 2006/0022574 A1
(43) Pub. Date: Feb. 2, 2006

(54) Light source apparatus using field emission cathode

(75) Inventors: Pi-Jin Chen, Beijing (CN); Peng Liu, Beijing (CN); Lei-Mei Sheng, Beijing (CN); Yang Wei, Beijing (CN); Liang Liu, Beijing (CN); Zhao-Fu Hu, Beijing (CN); Cai-Lin Guo, Beijing (CN); Shou-Shan Fan, Beijing (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignees: Tsinghua University, Beijing City (CN); HON HAI Precision Industry CO., LTD., Tu-Cheng City (TW)

(21) Appl. No.: 11/184,662

(22) Filed: Jul. 19, 2005

(30) Foreign Application Priority Data
Jul. 30, 2004 (CN) 200410050974.7

(51) Int. Cl. H01J 9/02; H01J 1/62

(52) U.S. Cl. 313/495; 313/310

(57) ABSTRACT

A light source apparatus (8) includes a rear plate (80), a front plate (89) formed with an anode layer (82), and a cathode (81) interposed therebetween. The cathode includes a plurality of electrically conductive carriers (812) and a plurality of field emitters (816) formed thereon. The field emitters are uniformly distributed on anode-facing surfaces of the conductive carriers. The anode layer includes a plurality of curving portions (820) corresponding to the conductive carriers. Preferably, the field emitters extend radially outwardly from the corresponding conductive carriers. The conductive carriers are parallel with each other, and are located substantially on a common plane. Each of the conductive carriers can be connected with a pulling device arranged at least one end thereof, and an example of the pulling device is a spring. The conductive carriers may be cylindrical, prism-shaped or polyhedral.

### CROSS-REFERENCE TO RELATED APPLICATION

This application is related to a copending U.S. utility patent application entitled “FIELD EMISSION CATHODE AND LIGHT SOURCE APPARATUS USING SAME” having the same assignees thereof, which is entirely incorporated herein by reference.

### FIELD OF THE INVENTION

The present invention relates to light source apparatuses, and more particularly to a light source apparatus having a field emission cathode.

### BACKGROUND

Fluorescent lamps are very popular light sources. A fluorescent lamp is a gas discharge tube. Generally, an inner surface of the wall of the tube is coated with light-emitting materials. Such light-emitting materials are usually fluorescent or phosphorescent metallic salts. The tube is filled with mercury vapor at extremely low pressure, and filaments are provided at each end of the tube. The light of the fluorescent lamp is not produced by an incandescent body (such as the filament of an ordinary electric lamp), but is emitted as a result of the excitation of atoms (namely, those of the mercury vapor and the fluorescent coating). Detailedly, electrons ejected from the cathode filaments collide with the mercury atoms of the vapor, and cause the mercury atoms to emit radiation. The radiation is mostly ultraviolet rays, which are invisible. The ultraviolet light strikes the fluorescent materials on the inner surface of the wall of the tube. Typically, this causes the fluorescent materials to emit radiation with a longer wavelength in the visible range of the spectrum. In this way, the coating transform the invisible ultraviolet rays into visible light.

A fluorescent lamp has certain advantages. Most notably, operation of the fluorescent lamp is highly economical compared to other light sources such as electric lamps. However, the fluorescent lamp also has certain drawbacks. For example, ultraviolet light needs to be transformed into visible light. Thus a certain amount of loss of light energy is inevitable. Further, there is a delay between powering on of the fluorescent lamp and the time when it begins to provide steady illumination. Additionally, relatively complicated control equipment is needed, which requires extra space. Moreover, some materials used in the fluorescent lamp, particularly mercury vapor, are liable to pollute the environment.

What is needed, therefore, is a clean light source with high light emission efficiency.

### SUMMARY

A light source apparatus provided herein generally includes a field emission cathode and a first anode facing toward the field emission cathode. The field emission cathode includes a plurality of electrically conductive carriers and a plurality of field emitters formed thereon. The first anode includes a plurality of curving portions corresponding to the conductive carriers.

In one exemplary embodiment, the light source apparatus further includes a second anode, and wherein the field emission cathode is arranged between the first and second anodes. The second anode preferably includes a plurality of curving portions corresponding to the conductive carriers.

Preferably, the light source apparatus may further include a grid electrode arranged between the first anode and the field emission cathode. The conductive carriers are parallel with each other, and are located substantially on a common plane. The field emitters may extend radially outwardly from the corresponding conductive carriers. Each of the conductive carriers can be connected with a pulling device arranged at least one end thereof, and an example of the pulling device is a spring. The conductive carriers may be cylindrical, prism-shaped or polyhedral. Each of the conductive carriers may be located substantially on a core of a corresponding curving portion thereof.

A material of the field emitters may be selected from metals, non-metals, compositions, and one-dimension nanomaterials.

These and other features, aspects and advantages will become more apparent from the following detailed description and claims, and the accompanying drawings.

### BRIEF DESCRIPTION OF THE DRAWINGS

FIG. 1 is a schematic, simplified, isometric view of a light source apparatus in accordance with a first embodiment of the present invention.

FIG. 2 is a cross-sectional view of the light source apparatus shown in FIG. 1, taken along line II-II thereof.

FIG. 3 is a schematic, simplified, isometric view of a light source apparatus in accordance with a second embodiment of the present invention.

FIG. 4 is a cross-sectional view of the light source apparatus shown in FIG. 3, taken along line IV-IV thereof.

### DETAILED DESCRIPTION OF THE PREFERRED EMBODIMENTS

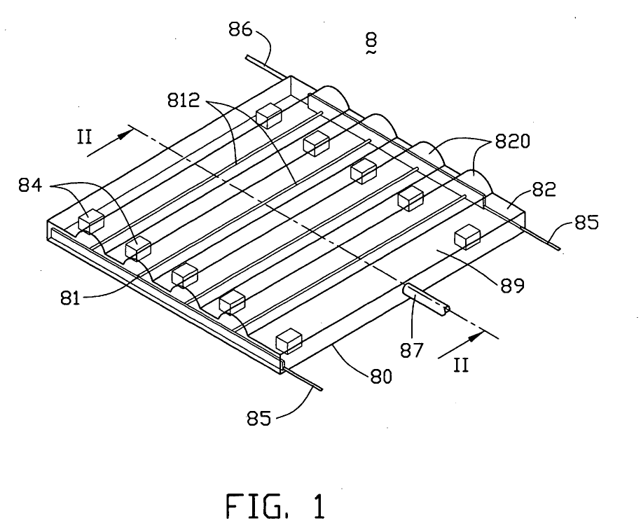

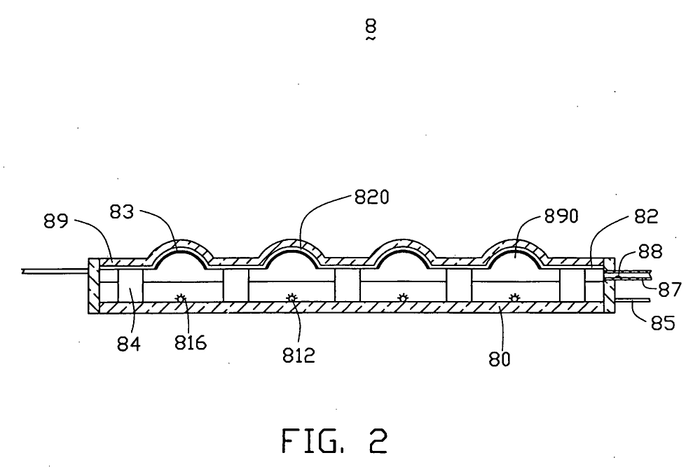

Referring to FIGS. 1 and 2, a light source apparatus 8 according to a first embodiment of the present invention is shown. The light source apparatus 8 has one lighting surface. As a general overview, the light source apparatus 8 includes a rear plate 80, a front plate 89 formed with an anode layer 82, and a cathode 81 interposed therebetween. The front plate 89 and the rear plate 80 are flat and parallel with each other. Four sides of the light source apparatus 8 are sealed by glass plates. A plurality of transparent supporting poles 84 which are made of glass are located between the front plate 89 and the rear plate 80, for strengthening the structure of the light source apparatus 8. An inner space of the light source apparatus 8 is substantially a vacuum.

The cathode 81 includes a plurality of electrically conductive carriers 812, and a plurality of field emitters 816 formed thereon. The field emitters 816 are uniformly distributed on anode-facing surfaces of the conductive carriers 812. Preferably, the field emitters 816 extend radially outwardly from the corresponding conductive carriers 812. Consequently, any shielding effect between adjacent field emitters 816 is minimized. Accordingly, an electron-emitting effect of the cathode 81 is increased, and an overall performance of the light source apparatus 8 is improved. In the illustrated embodiment, the carriers 812 are cylindrical, and are parallel with each other. Intervals between two neighboring carriers 812 are uniform. As a result, the field emitters 816 formed on the carriers 812 cooperatively constitute a field emission array. Preferably, the carriers 812 are identical in shape and size, and central axes thereof are arranged substantially in a same common plane. That is, the cathode 81 can provide a flat field emission array. Thereby, a substantially planar light source is achieved, and additional corrective optical components can be omitted.

The cathode 81 is secured by two holding sheets (not labeled), which are located on the rear plate 80 and abut two sides of the light source apparatus 8 respectively. Two cathode down-leads 85 are arranged on two sides of the cathode 81, for providing electrical connections with each of the carriers 812.

In the illustrated embodiment, the carriers 812 are conductive filaments. The field emitters 816 are formed on the carriers 812 by electrophoresis, chemical vapor deposition (CVD), or another suitable method. The carriers 812 formed with the field emitters 816 are secured on the holding sheets, with uniform spaces between the carriers 812. The cathode 81 is thereby formed. Alternatively, the carriers 812 can be secured on the holding sheets before the field emitters 816 are deposited on the carriers 812.

The field emitters 816 have micro-tips, which may for example be tungsten micro-tips, zinc oxide micro-tips, or diamond micro-tips. In general, a material of the field emitters 816 is selected from metals, non-metals, compositions, and one-dimensional nanomaterials. The compositions include zinc oxide and other materials known in the art. The one-dimensional nanomaterials may include nanotubes, nanowires, or the like; for example, carbon nanotubes, silicon nanowires, or molybdenum nanowires.

The front plate 89 is generally made of plate. A plurality of grooves 890 are formed on the front plate 89, with openings of the grooves 890 facing toward the carriers 812 respectively. In this embodiment, cross-sectional shapes defined by the grooves 890 are arcuate. In other examples, the grooves may define cross sections that are V-shaped, semicircular, or polygonal. It is preferable that each of the carriers 812 is located directly opposite a center of a corresponding groove 890, for obtaining a better emission effect. The anode layer 82 is a transparent conductive layer formed on a cathode-facing surface of the front plate 89. This can be obtained by depositing indium-tin oxide on the cathode-facing surface. The anode layer 82 includes a plurality of curving portions 820 formed on inner surfaces of the front plate 89 in the grooves 890. Accordingly, the curving portions 820 face toward the carriers 812 respectively.

Fluorescent layers 83 are formed on the curving portions 820 of the anode layer 82, corresponding to each of the carriers 812. The fluorescent layers 83 contain red, green, and yellow fluorescent materials. Alternatively, the fluorescent layers 83 contain white fluorescent materials. Additionally, the anode layer 82 can be formed in parallel strips corresponding to the fluorescent layers 83, or the fluorescent layers 83 can be formed like a plate on the anode layer 82. An anode down-lead 86 is arranged on one side of the anode layer 82, for providing current to the anode layer 82.

It is noted that a substantially planar light source can be achieved if the grooves 890 are sufficiently small, and if a density of the grooves 890 is sufficiently large. Moreover, a particular brightness of the light source apparatus 8 is a function of many factors, such as a voltage and current density of the anode layer 82, and an emitting effect of the fluorescent materials. Such factors can be configured according to need in order to obtain a desired brightness.

One side wall of the light source apparatus 8 defines a vent hole (not labeled), and a vent pipe 87 is engageably received in the vent hole. The vent pipe 87 has a getter 88 on an inner wall thereof, for maintaining a high vacuum of the light source apparatus 8.

Alternatively, if desired, a grid electrode can be arranged between the anode layer 82 and the cathode 81, for extracting electrons from the field emitters 816. For example, the grid electrode can be a metallic net patterned by lithography. Generally, an electron-emitting effect of the field emitters 816 can be increased accordingly.

The light source apparatus 8 has many advantages shared by field emission devices in general. Field emission devices are based on emission of electrons in a vacuum in order to produce visible light. Electrons are emitted from micron-sized tips in a strong electric field, and the electrons are accelerated and collide with a fluorescent material. The fluorescent material then emits visible light. The loss of light energy of a field emission device is markedly lower than that of a conventional fluorescent lamp, therefore a field emission device can provide high brightness. In addition, a light source using a field emission cathode is thin and light. Furthermore, a field emission device does not use any materials that can harm the environment.

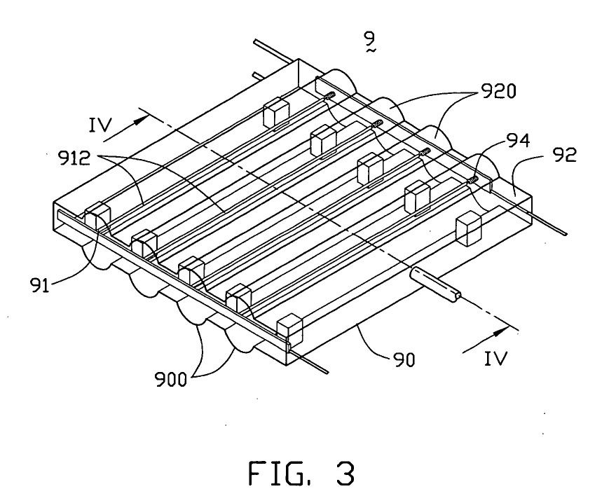

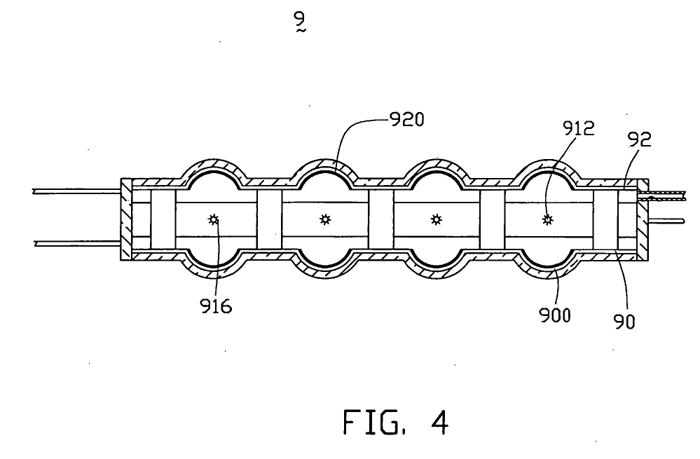

Referring to FIGS. 3 and 4, a light source apparatus 9 according to a second embodiment of the present invention is shown. The light source apparatus 9 has two lighting surfaces. The main difference between the two light source apparatuses 8 and 9 is that in the second embodiment, the light source apparatus 9 includes two anode layers 90, 92, and a cathode 91 located therebetween. Further, the cathode 91 includes a plurality of conductive carriers 912, and a plurality of field emitters 916 formed on both sides of each of the carriers 912 facing toward the two anode layers 90, 92. The two anode layers 90, 92 include curving portions 900, 920, respectively. The curving portions 900, 920 face toward each other. Each of the carriers 912 is located directly opposite a center of the corresponding curving portion 900 and a center of the corresponding curving portion 920. If desired, one of the two anodes 90, 92 can be formed as a flat plate with no curving portions.

Additionally, in the second embodiment, each of the carriers 912 has one end secured on a holding sheet by a spring 94. The spring 94 pulls the carrier 912 and keeps it straight. More particularly, the spring 94 has one flexible end connected with the end of the corresponding carrier 912, and another end fixed on the holding sheet. Accordingly, the carriers 912 are accurately maintained in a common plane. This helps ensure that electron emission is relatively uniform. In addition, the cathode 91 is more stable, and the useful working lifetime of the whole light source apparatus 9 can be increased. Alternatively, each of the carriers 912 can have its both ends connected with springs 94, for providing a better pulling effect.

It should be noted that the carriers may have other shapes suitably adapted for practicing the present invention. For example, the carriers may be prism-shaped or polyhedral. Furthermore, other pulling devices such as filaments can be employed to keep the carriers straight. Moreover, it will be apparent to those skilled in the art that some factors, for example, the number of the carriers, the means for holding the carriers, and the arrangement of down-leads of the electrodes, can be changed according to particular need. In summary, the particular light source apparatuses described above are not critical to practicing the present invention.

It should be further noted that the light source apparatuses 8, 9 can be used in a variety of applications requiring illumination, particularly where a planar light source is required.

Finally, while the present invention has been described with reference to particular embodiments, the description is intended to be illustrative of the invention and is not to be construed as limiting the invention. Therefore, various modifications can be made to the embodiments by those skilled in the art without departing from the true spirit and scope of the invention as defined by the appended claims.

We claim:

1. A light source apparatus comprising:
a field emission cathode including a plurality of electrically conductive carriers, and a plurality of field emitters formed on the conductive carriers;
a first anode facing toward the field emission cathode, the first anode including a plurality of curving portions corresponding to the conductive carriers.

2. The light source apparatus according to claim 1, further comprising a grid electrode arranged between the first anode and the field emission cathode.

3. The light source apparatus according to claim 1, further comprising a second anode, and wherein the field emission cathode is arranged between the first and second anodes.

4. The light source apparatus according to claim 3, wherein the second anode includes a plurality of curving portions corresponding to the conductive carriers.

5. The light source apparatus according to claim 1, wherein the conductive carriers are parallel with each other, and are located substantially in a common plane.

6. The light source apparatus according to claim 1, wherein the field emitters extend radially outwardly from the corresponding conductive carriers.

7. The light source apparatus according to claim 1, wherein a material of the field emitters is selected from the group consisting of metals, non-metals, compositions, and one-dimensional nanomaterials.

8. The light source apparatus according to claim 1, wherein at least one end of each of the conductive carriers is connected with a pulling device.

9. The light source apparatus according to claim 8, wherein the pulling device is a spring.

10. The light source apparatus according to claim 1, wherein the conductive carriers are cylindrical, prism-shaped, or polyhedral.

11. The light source apparatus according to claim 1, wherein each of the conductive carriers is located substantially on a core of a corresponding curving portion thereof.

12. A light source apparatus comprising:
at least one lighting surface of said apparatus for being light-viewable outside said apparatus through said at least one lighting surface;
an electrifiable cathode disposed in said apparatus next to said at least one lighting surface and comprising a plurality of field emitters formed thereon and electrically connected therewith, each of said plurality of field emitters substantially pointing to said at least one lighting surface and electrifiable with said cathode to emit electrons therefrom; and
an anode layer disposed between said cathode and said at least one lighting surface and spaced from said cathode to be electrifiable to accept said electrons from said plurality of field emitters for light emission of said apparatus, parts of said anode layer being arranged in a manner of substantially crossing pointing directions of said plurality of said field emitters.

13. The light source apparatus according to claim 12, wherein said cathode includes a plurality of electrically conductive carriers, and said plurality of field emitters are formed on each of said plurality of carriers.

14. A light source apparatus comprising:
at least one lighting surface of said apparatus for being light-viewable outside said apparatus through said at least one lighting surface;
an electrifiable cathode disposed in said apparatus beside said at least one lighting surface, said cathode comprising a plurality of electrically conductive carriers, and each of said plurality of carriers having a plurality of field emitters formed thereon and electrically connected therewith to be electrifiable for emitting electrons therefrom; and
an anode layer disposed between said lighting surface and said cathode and spaced from said cathode, said anode layer having a portion substantially surrounding emitter-formed parts of said each of said plurality of carriers so as to accept said electrons from said plurality of field emitters for light emission of said apparatus.

15. The light source apparatus according to claim 14, wherein said portion of said anode layer is curving.
